(19) United States
(12) Patent Application Publication
(10) Pub. No.: US 2026/0152942 A1
(43) Pub. Date: Jun. 4, 2026

(54) STRUCTURAL PANEL WITH FIRE-RESISTANT INSULATING LAYER

(71) Applicant: LOUISIANA-PACIFIC CORPORATION, NASHVILLE, TN (US)

(72) Inventor: SCOTT JOHNSON, PORTLAND, OR (US)

(21) Appl. No.: 19/409,438

(22) Filed: Dec. 4, 2025

Related U.S. Application Data
(60) Provisional application No. 63/727,863, filed on Dec. 4, 2024.
(60) Provisional application No. 63/750,854, filed on Jan. 29, 2025.

(51) Int. Cl. E04C 2/296; E04B 1/94

(52) U.S. Cl. CPC E04C 2/296; E04B 1/942

(57) ABSTRACT

A multi-layer insulated panel product for use in residential and commercial construction, including, but not limited to, for use as structural sheathing. The multi-layer panel product has a base panel substrate, which may be a manufactured wood, gypsum, plastic, or some other similar material, with a fire-resistant insulating layer affixed to a face of the base panel substrate. The insulating layer may be pre-affixed to the base panel substrate in the factory or on a production line, prior to transport and installation at a job site. An insulating layer may be affixed to two base panel substrates, one on each side of the insulating layer.

This application claims priority to and benefit of U.S. Provisional Applications No. 63/727,863, filed Dec. 4, 2024, and No. 63/750,854, filed Jan. 29, 2025, both of which are incorporated herein their entireties by specific reference for all purposes.

### FIELD OF INVENTION

This invention relates to a multi-layered panel (which can be wood-based, such as oriented strand board, plywood, or other cellulosic panel, metal, gypsum, other suitable materials, or combinations thereof) with a fire-resistant insulating layer.

### BACKGROUND OF THE INVENTION

Building wall, floor and/or roof assemblies are typically layers of several materials, each performing a single function, that are installed separately on the site in which the building is being constructed. Compatibility between the various layers creates challenges not only for the designer, but also for the installers.

A typical layer in most such assemblies is a wood panel product, or an integral composite engineered panel product, including, but not limited to, engineered wood composite products formed of lignocellulosic strands or wafers (sometimes referred to as oriented-strand board, or OSB). Products such as fiberboard and particleboard have been found to be acceptable alternatives in most cases to natural wood paneling, sheathing and decking lumber. Fiberboard and particleboard are produced from wood particles bonded together by an adhesive, the adhesive being selected according to the intended use of and the properties desired for the lumber. Often times, the adhesive is combined with other additives to impart additional properties to the lumber. Additives can include fire retardants, insect repellants, moisture resistance, fungus resistance, and color dyes. A significant advantage of fiberboard and particleboard lumber products is that they have many of the properties of plywood, but can be made from lower grade wood species and waste from other wood product production, and can be formed into lumber in lengths and widths independent of size of the harvested timber.

A major reason for increased presence in the marketplace of the above-described product alternatives to natural solid wood lumber is that these materials exhibit properties like those of the equivalent natural solid wood lumber, especially, the properties of retaining strength, durability, stability, and finish under exposure to expected environmental and use conditions. A class of alternative products are multilayer oriented wood strand particleboards, particularly those with a layer-to-layer oriented strand pattern, such as OSB. Oriented, multilayer wood strand boards are composed of several layers of thin wood strands, which are wood particles having a length which is several times greater than their width. These strands are formed by slicing larger wood pieces so that the fiber elements in the strands are substantially parallel to the strand length. The strands in each layer are positioned relative to each other with their length in substantial parallel orientation and extending in a direction approaching a line which is parallel to one edge of the layer. The layers are positioned relative to each other with the oriented strands of adjacent layers perpendicular, forming a layer-to-layer cross-oriented strand pattern. Oriented, multilayer wood strand boards of the above-described type, and examples of processes for pressing and production thereof, are described in detail in U.S. Pat. Nos. 3,164,511, 4,364,984, 5,435,976, 5,470,631, 5,525,394, 5,718,786, and 6,461,743, all of which are incorporated herein in their entireties by specific reference for all purposes.

Certain oriented board products can be made from flakes that are created from debarked round logs by placing the edge of a cutting knife parallel to a length of the log and the slicing thin flakes from the log. The cut flakes are subjected to forces that break the flakes into strands having a length parallel to the grain of the wood several times the width of the strand. The strands can be oriented on the board-forming machine with the strands predominantly oriented in a single (e.g., cross-machine) direction in one (e.g., core) layer and predominantly oriented in the generally perpendicular (machine) direction in adjacent layers. The various layers are bonded together by natural or synthetic resins under heat and pressure to make the finished product. Oriented, multilayer wood strand boards of the above-described type are produced with bending, tensile strengths and face strengths comparable to those of commercial softwood plywood.

Building wall, floor and/or roof assemblies typically are constructed by attaching several panels of the above-described type as to an underlying supporting structure frame as “sheathing.” These sheathing panels are often placed in a pattern with the edge of each panel contacting or positioned close to adjacent panels, thereby forming a substantially continuous flat surface. In certain types of construction, the panels (and other construction materials) may be required under applicable building codes and/or practices to meet certain weather resistance or water resistance requirements.

For certain applications and/or locations, panels or panel assemblies are required to meet certain fire resistance ratings under applicable codes (i.e., Fire-Rated sheathing). Fire ratings indicate that the panel assembly is built to withstand the heat from a fire for a certain period of time before failing. Typical fire ratings are referred to as one-hour and two-hour ratings. According to the American Standards for Testing Materials (ASTM), for example, a one-hour rating indicates that a wall or floor constructed in a manner similar to the one tested will contain flames and high temperatures, and will support its full load for at least one hour after the fire begins. Thus, for example, a Fire-Rated OSB sheathing can be used as a component in a 1-hour and/or 2-hour UL-listed (Underwriter Laboratories) fire-rated wall or floor assembly. An OSB panel typically has a class C flame spread rating.

Sheathing panels of this type also are often used in construction as part of a structure, and thus are frequently exposed to adverse weather conditions, including rain and other forms of water or moisture. In prior art applications, a fire-resistant panel is installed as sheathing at a job or construction site. After installation, a code-approved water resistant barrier (WRB) system or material is applied. Examples of these WRB systems include housewrap (e.g. Tyvek, Typar), peel-and-stick membranes, or a WRB fluid or liquid applied to the installed panel. However, these systems all rely upon skilled labor for installation at the job. In addition, many of the systems cannot be installed during inclement weather, and require the installed sheathing to be free of defects and provide a clean surface free of debris in order to achieve proper adhesion between the panel and the WRB. As a result, all of these systems can be problematic to install on a job site, and often result in improper installation causing failures in the building “envelope,” leading to problems such as moisture instruction or mold or mildew growth.

Also, in many locations, some form of insulation is often required in a roof, floor or wall construction, helping to protect and maintain the interior of a structure from high or low temperatures. Insulation typically is added during or after installation of structural panels. However, the application of multiple barrier layers or other layers of various types to both faces of a panel substantially increases the cost and complexity of the manufacturing process. For example, the layers typically require separate application, curing and application before additional layers are added.

### SUMMARY OF INVENTION

In various exemplary embodiments, the present invention comprises a multi-layer insulated panel product for use in residential and commercial construction, including, but not limited to, for use as structural sheathing. The multi-layer panel product comprises a base panel substrate, which may be a manufactured wood (such as OSB or plywood), gypsum, plastic, or some other similar material, with a fire-resistant insulating layer affixed to a face of the base panel substrate to produce or manufacture the multi-layer insulated panel product. The insulating layer may be pre-affixed to the base panel substrate in the factory or on a production line, prior to transport and installation at a job site, or in other embodiments, the insulating layer may be affixed or fastened to the base panel substrate in the field or at the job site. In some embodiments, an insulating layer may be affixed to two base panel substrates, one on each side of the insulating layer.

In one exemplary embodiment, the base panel substrate and insulating layer are sequentially installed on a wall or framing at the job site (i.e., not as a previously integrated product). The base panel substrate is first secured or attached to the wall or framing by nails, screws or similar fasteners. Next, the insulating layer is attached to the outer face of the base panel substrate by adhesive, glue, staples, or similar fastening or adhering means.

The insulating layer may be rigid or semi-rigid, including, but not limited to, mineral wool, foam, fiberglass, cellulose or similar insulating material. The insulating layer may be glued or adhered to the base panel substrate, mechanically fastened to the base panel substrate, or otherwise affixed thereto. The insulated panel product may be used in vertical and/or horizontal applications where the fire resistance is provided by the insulated panel product itself, and does not rely on additional components (such as floor or wall framing), or specialty hardware (such as specialty clips, break-away hardware components, and/or specialty metals).

In several embodiments, the rigid insulation is chosen such that the insulated panel product has fire resistance-ratings in accordance with ASTM E119, 30-minute to 3-hour fire resistance, and meets building code requirements as determined by the ASTM E84 standard test for surface burning characteristics of building products.

In some embodiments, the base panel substrate is a panel with a cementitious fire-resistant coating on one or both faces, and/or with fire-retardant treatment(s) applied to the surface of the panel or incorporated into the material from which the base panel substrate is made. This provides additional fire-resistance to the insulated panel product.

The base panel substrate may have the insulating layer on a single face or on both faces. In several embodiments, two insulated panel products may be each mounted on opposite sides of a framing component, or on two framing components. In one embodiment, two base panel substrates “sandwich” an insulating layer between them.

### BRIEF DESCRIPTION OF THE DRAWINGS

FIG. 1 shows a cross-section view of an embodiment of a multi-layer insulated panel product with a single panel substrate with insulation on both faces.

FIG. 2 shows a cross-section view of an embodiment of a multi-layer insulated panel product with a single panel substrate with insulation on one face.

FIG. 3 shows a cross-section view of an embodiment of two multi-layer insulated panel products on both sides of a single piece of framing.

FIG. 4 shows a cross-section view of an embodiment with two pieces of framing each with a multi-layer insulated panel product with a single panel substrate with insulation on opposite faces.

FIG. 5 a cross-section view of an embodiment of a multi-layer insulated panel product with two panel substrates with a single insulation layer therebetween.

FIG. 6 shows a method of installing a multi-layer insulated panel product as a unit.

FIG. 7 shows a method of installing multi-layer insulated panel product as individual components on framing.

### DETAILED DESCRIPTION OF EXEMPLARY EMBODIMENTS

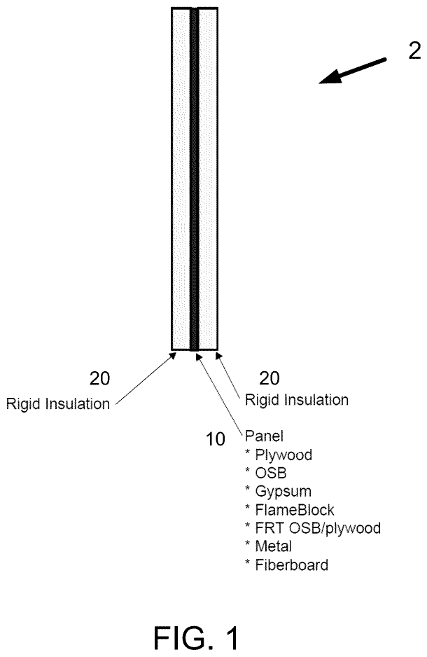

In various exemplary embodiments, as seen in FIGS. 1-3, the present invention comprises a multi-layer insulated panel product 2 for use in residential and commercial construction, including, but not limited to, for use as structural sheathing. The multi-layer panel product as shown comprises a base panel substrate 10, which may be a manufactured wood (such as OSB or plywood), gypsum, plastic, or some other similar material, with a fire-resistant insulating layer 20 affixed to a face of the base panel substrate 10 to produce or manufacture the multi-layer insulated panel product 2. The insulating layer 20 may be pre-affixed to the base panel substrate in the factory or on a production line, prior to transport and installation at a job site, or in other embodiments, the insulating layer may be affixed or fastened to the base panel substrate in the field or at the job site. In some embodiments, an insulating layer may be affixed to two base panel substrates, one on each side of the insulating layer.

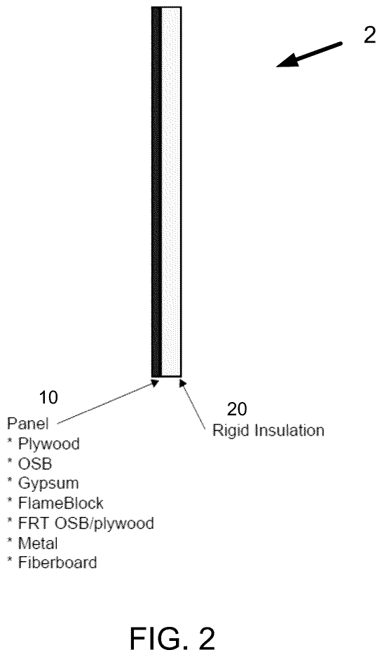

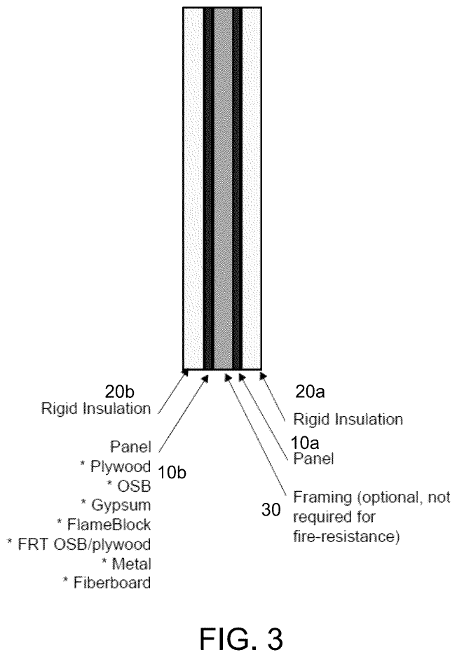

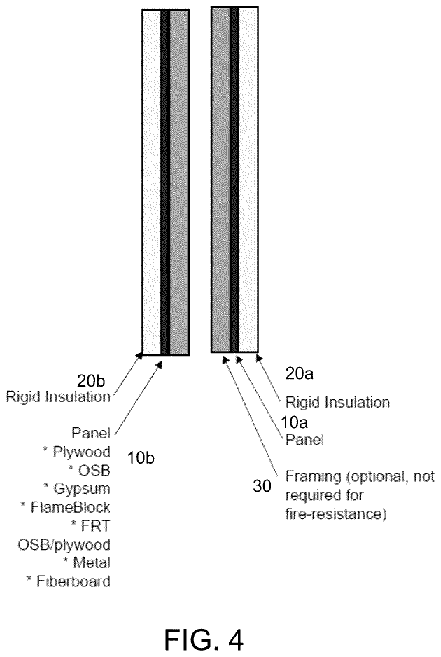

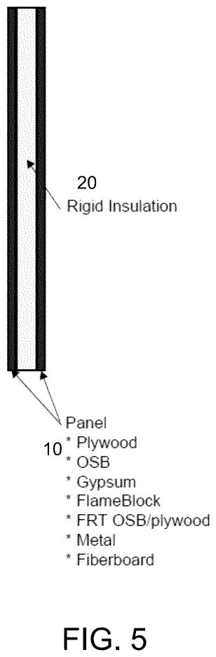

As seen in FIGS. 1 and 2, the base panel substrate 10 may have the insulating layer 20 on a single face or on both faces. FIGS. 3 and 4 show two insulated panel products comprising a base panel substrate 10a,b, and corresponding insulating layer 20a, mounted on opposite sides of a single framing component 30 (FIG. 3), or on two framing components (FIG. 4). FIG. 5 shows an embodiment with two base panel substrates 10 “sandwiching” an insulating layer 20 between them.

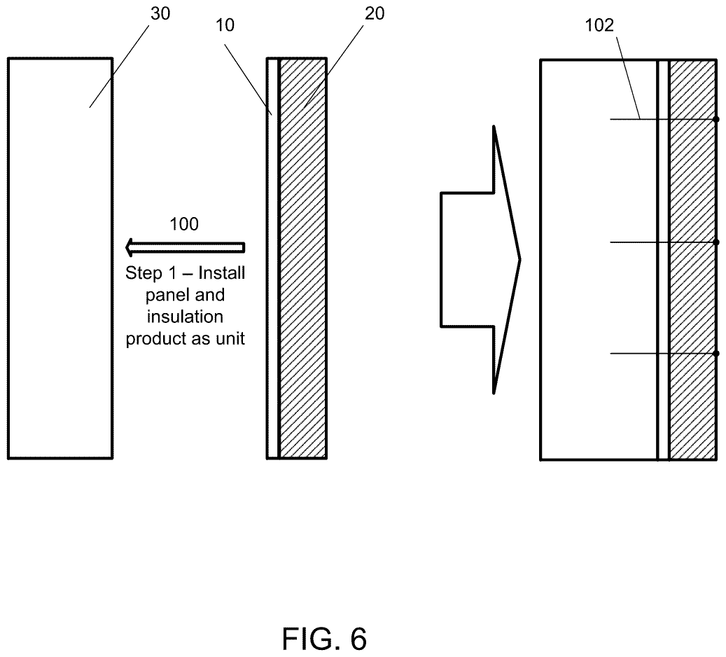

FIG. 6 shows an exemplary embodiment where the pre-formed, integrated base panel substrate and insulating layer product 4 are installed 100 as a unit on a wall, floor, roof or other framing 30 at the job site

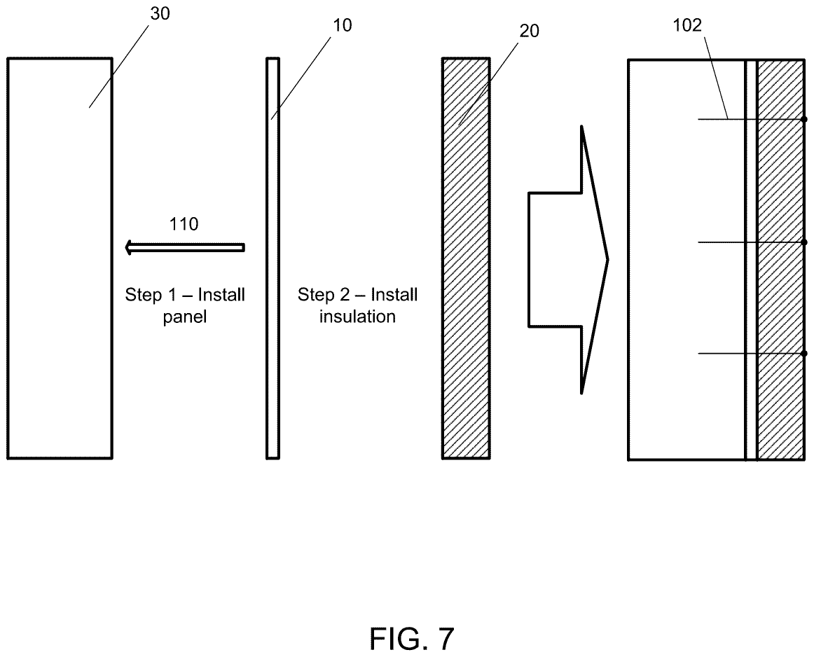

FIG. 7 shows an alternative exemplary embodiment where the base panel substrate 10 and insulating layer 20 are sequentially installed on a wall, floor, roof or other framing 30 at the job site (i.e., not as a previously integrated product). The base panel substrate is first secured or attached 110 to the wall or framing by nails, screws or similar fasteners. Next, the insulating layer is secured or attached 120 to the outer face of the base panel substrate by adhesive, glue, staples, or similar fastening or adhering means.

The insulating layer may be rigid or semi-rigid, including, but not limited to, mineral wool, foam, fiberglass, cellulose or similar insulating material. The insulating layer may be glued or adhered to the base panel substrate, mechanically fastened to the base panel substrate, or otherwise affixed thereto. The insulated panel product may be used in vertical and/or horizontal applications where the fire resistance is provided by the insulated panel product itself, and does not rely on additional components (such as floor or wall framing or assembly), or specialty hardware (such as specialty clips, break-away hardware components, and/or specialty metals).

In several embodiments, the rigid insulation is chosen such that the insulated panel product (i.e., panel substrate and insulation) by itself has fire resistance-ratings that meet at least the minimum requirements in accordance with ASTM E119 (last updated Jun. 10, 2024) “Standard Test Methods for Fire Tests of Building Construction and Materials,” 30-minute to 3-hour fire resistance, and any future updates, and meets building code requirements as determined by the ASTM E84 (last updated Aug. 4, 2024) “Standard Test Method for Surface Burning Characteristics of Building Materials,” standard or extended to a full 30-minutes as required by building codes, and any future updates, and/or the ASTM E2768 (reapproved 2018) “Standard Test Method for Extended Duration Surface Burning Characteristics of Building Materials (30 min Tunnel Test),” and any future updates. The minimum requirements include passing and not failing the applicable tests.

In further embodiments, the base panel substrate is a panel with a cementitious fire-resistant coating on one or both faces, and/or with fire-retardant treatment(s) applied to the surface of the panel or incorporated into the material from which the base panel substrate is made. This provides additional fire-resistance to the insulated panel product.

The insulated panel can also be installed in the field as separate components. As seen in FIG. 7, the base panel substrate 10 may be attached to the framing 30 first, with the insulation 20 then installed over the panel substrate 10. The insulation may be connected or attached to the panel but not the framing, or alternatively, may be connected or attached to both the panel and the framing (e.g., the nail, screw, or other fastener 102 may extend all the way through the panel and into the framing). The initial step of panel attachment to the framing can be such that it provides structural strength and capacity, such as resisting in-plane shear. Alternatively, for non-structural applications, the panel may be more simply tacked into place, with the subsequent attachment of the insulation comprising driving fasteners 102 through the panel and into the framing providing positive connection for both the panel and insulation to the framing.

The insulated panel product described above provides at least equivalent fire-resistance of prior art floor (horizontal) and wall (vertical) fire-resistance-rated assemblies, but with a reduction in the among of components. Further, prior art floor and wall assemblies require multiple inspections as the assemblies at multiple stages during the construction of the assemblies. With the present invention, the number of inspections required is greatly reduced, and in most cases only a single inspection will be required.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A panel product, comprising:
a first base panel substrate with a first side and a second side; and
a first insulating layer with a first side and a second side, wherein the first side of the first insulating layer is affixed to the first side of the first base panel substrate;
wherein the panel product has at least a 30-minute fire resistance rating as determined by ASTM E1119.

2. The panel product of claim 1, further comprising a second insulating layer affixed to the second side of the first base panel substrate.

3. The panel product of claim 1, wherein the second side of the first base panel substrate is affixed to a first side of a framing component.

4. The panel product of claim 3, further comprising:
a second base panel substrate with a first side and a second side; and
a second insulating layer with a first side and a second side, wherein the first side of the second insulating layer is affixed to the first side of the second base panel substrate, and the second side of the second base panel substrate is affixed to a second side of the framing component.

5. The panel product of claim 1, wherein the first insulating layer is rigid.

6. The panel product of claim 1, wherein the first insulating layer comprises mineral woold or fiberglass.

7. The panel product of claim 1, wherein the first insulating layer comprises foam.

8. The panel product of claim 1, where the first insulating layer comprises cellulose.

9. The panel product of claim 1, wherein the first base panel substrate comprises manufactured wood.

10. The panel product of claim 1, wherein the first base panel substrate comprises plastic.

11. The panel product of claim 1, wherein the first base panel substrate comprises gypsum.

12. The panel product of claim 1, wherein the first base panel substrate and the first insulating layer are pre-formed into an integral two-layer arrangement.

13. The panel product of claim 2, wherein the first base panel substrate, the first insulating layer, and the second insulating layer are pre-formed into an integral three-layer arrangement.

14. The panel product of claim 1, further comprising a second base panel substrate affixed to the second side of the first insulating layer.

15. The panel product of claim 14, wherein the first base panel substrate, the first insulating layer, and the second base panel substate are pre-formed into an integral three-layer arrangement.
